(19) United States
(12) Patent Application Publication
(10) Pub. No.: US 2008/0055086 A1
(43) Pub. Date: Mar. 6, 2008

(54) Overvoltage Protection Device and Radio Frequency Receiver and Radio Frequency Identification Tag Comprising such a Device

(75) Inventors: Eugenio Cantatore, Eindhoven (NL); Albert W. Marsman, Eindhoven (NL); Gerwin Gelinck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,913

(22) PCT Filed: Sep. 9, 2005
(86) PCT No.: PCT/IB05/52960

§ 371 Date: Mar. 8, 2007

(30) Foreign Application Priority Data
Sep. 14, 2004 (EP) 04104431.4

(51) Int. Cl. G08B 13/14

(52) U.S. Cl. 340/572.1

(57) ABSTRACT

An over voltage protection device on a radio frequency identification tag or in a radio frequency receiver comprises electro-magnetic coupling means between a base station and the radio frequency identification tag or radio frequency receiver. At least one ferroelectric capacitor is electrically connected to the coupling means. As long as the voltage across the ferroelectric capacitor remains below its coercive voltage, its capacitance will be linear and the tag or radio frequency receiver will behave normally. However, if the voltage across the ferroelectric capacitor exceeds the coercive voltage, the ferroelectric capacitance will experience polarization reversal and exhibit its non-linear and dissipative behavior. Connecting the ferroelectric capacitor in suitable ways to the coupling means, will result in a dumping of the voltage transferred to the electronics present on the tag or radio frequency receiver. This electronics is then protected against excessive voltages that could cause it damage.

The invention relates to an overvoltage protection device on a radio frequency identification tag or in a radio frequency receiver, comprising electro-magnetic coupling means between a base station and the radio frequency identification tag or radio frequency receiver.

Radio frequency receivers or radio frequency identification tags get the energy they need from electromagnetic waves that are sent by a base station. For this purpose, electro-magnetic coupling means are provided on the tag or in the receiver. Suitable circuits, preferably in the form of a resonant circuit, are connected to the electro-magnetic coupling means in such a way that the voltage received from the base station, and thus the reading distance, are maximized. The transmitting antenna and the tag electronics are normally manufactured on different substrates, which are coupled electrically and mechanically with a suitable bonding technique. The energy received by the tag or the receiver is usually rectified, conditioned and transferred to the electronics present on the receiver or the tag, normally as a DC bias voltage.

Assuming that the transmitting antenna emits power in the space around it in an isotropic way, the power density available at a certain point in the space is inversely proportional to the square of the distance between the given point and the transmitting antenna. Under otherwise ideal circumstances the DC voltage available on the chip, Vchip, will be typically inversely proportional to the distance between transmitting antenna and receiver or tag. This means that the voltage Vchip can differ substantially dependent on whether the receiver or tag is close or far from the transmitting antenna. The maximum value of Vchip, however, is typically limited (1-5V for silicon electronics, 20-40V for organic electronics).

When the receiver or tag approaches the base station, the received voltage rapidly increases. The voltage on the receiver or tag can then exceed the maximum voltage that the electronics can withstand, as a result of which the receiver or tag may be destroyed.

In silicon receivers or tags the electronics is protected against overvoltages by suitable circuits, generally based on p-n junction voltage references and transistors, as described for instance in U.S. Pat. No. 5,874,829, or by detuning by means of a serial configuration of a capacitor and a transistor, arranged in parallel with the resonant circuit and controlled by a voltage sensing circuit, as described in U.S. Pat. No. 6,229,443 B1. This approach according to the state of the art is impossible in organic electronics, as in organic circuits p-n junctions are not available. Also diode-connected transistors cannot be applied, as the only transistors available at the moment are pmos with a positive threshold, which means that the resulting diode would always be ON.

The purpose of the invention is to obtain another way of controlling the maximum voltage Vchip, not only for silicon receivers or tags but also for receivers or tags built with organic transistors.

Therefore, according to the invention, the overvoltage protection device as described in the opening paragraph is characterized by at least one ferroelectric capacitor that is electrically connected to the coupling means.

An overvoltage protection for organic receivers or tags is known per se from Chinese patent publication CN 1421479. The protection is based on the specific choice of organic polymer poly(ethylene naphtalene dicarboxylate), abbreviated PEN, as film material. This material may change its conductive state when voltages exceeding a certain threshold are applied.

The invention further relates to a radio frequency receiver and a radio frequency identification tag provided with such an overvoltage protection device.

The above and other objects and features of the present invention will become more apparent from the following detailed description considered in connection with the accompanying drawings, in which:

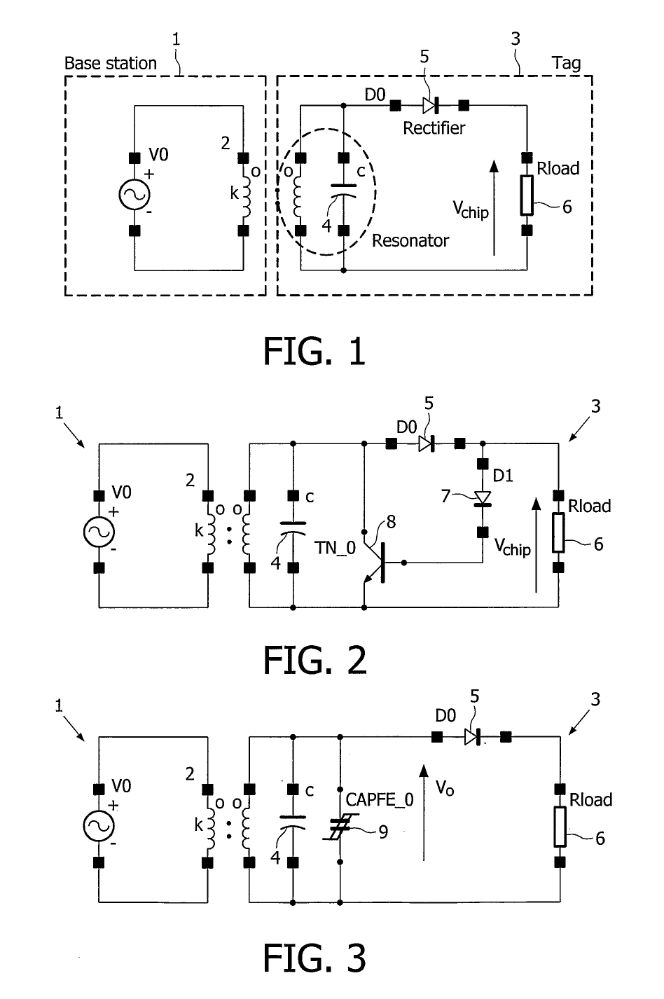

FIG. 1 shows schematically a base station and a radio frequency identification tag according to the state of the art;

FIG. 2 shows schematically an overvoltage protection arrangement in silicon tags according to the state of the art;

FIG. 3 shows schematically a radio frequency identification tag according to the invention;

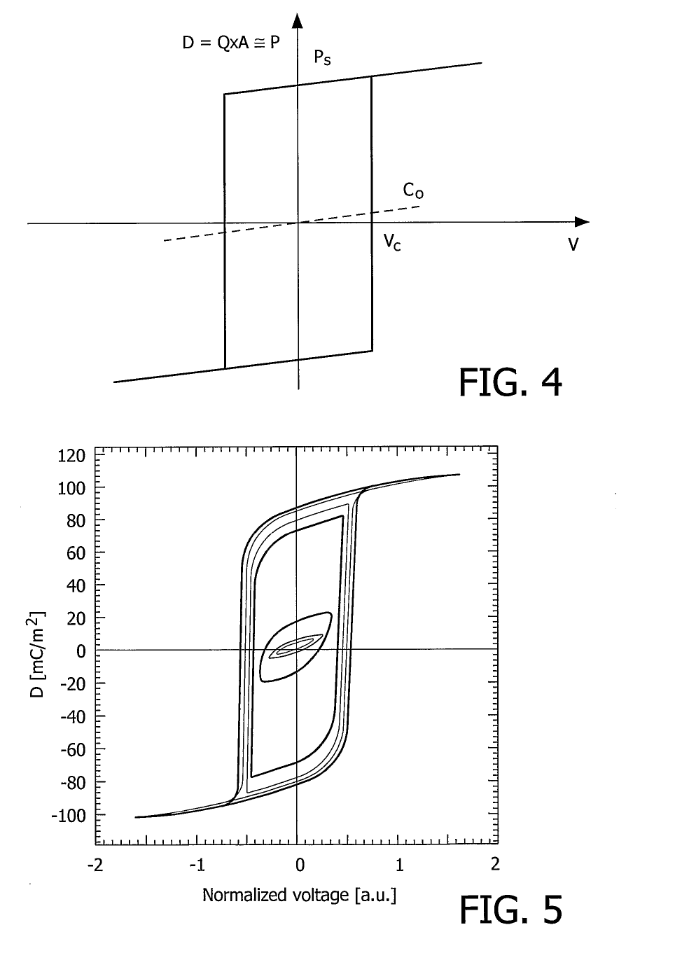

FIG. 4 shows the displacement D versus voltage characteristics of an ideal ferroelectric capacitor;

FIG. 5 shows the displacement versus voltage characteristics of a ferroelectric capacitor illustrating non-saturated loops;

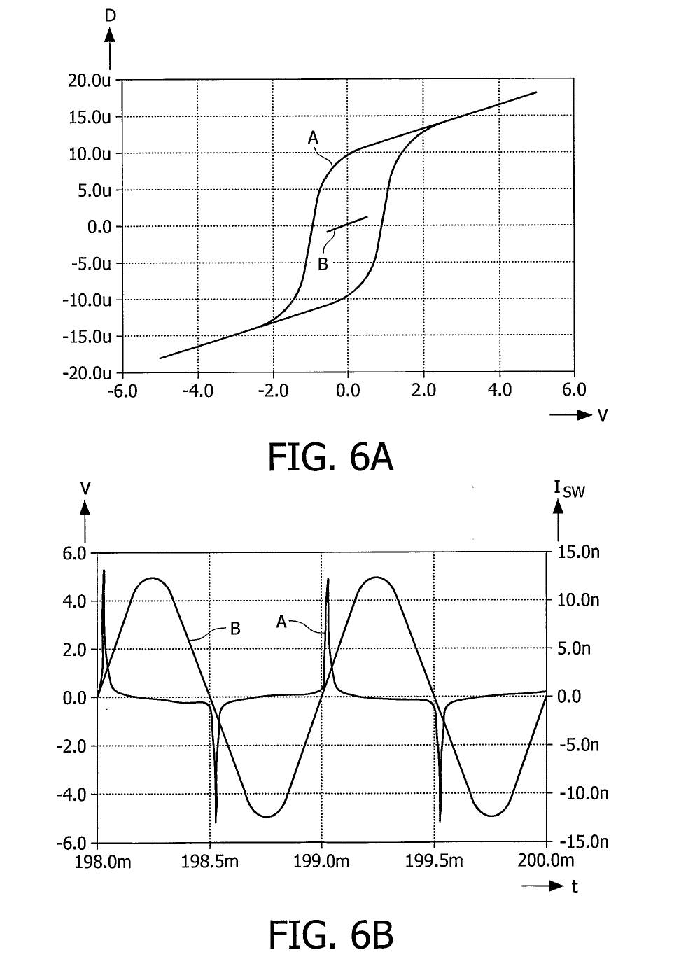

FIGS. 6A and 6B show the displacement versus voltage characteristics of a specific ferroelectric capacitor and the applied voltage and switching current versus time of this specific ferroelectric capacitor, respectively;

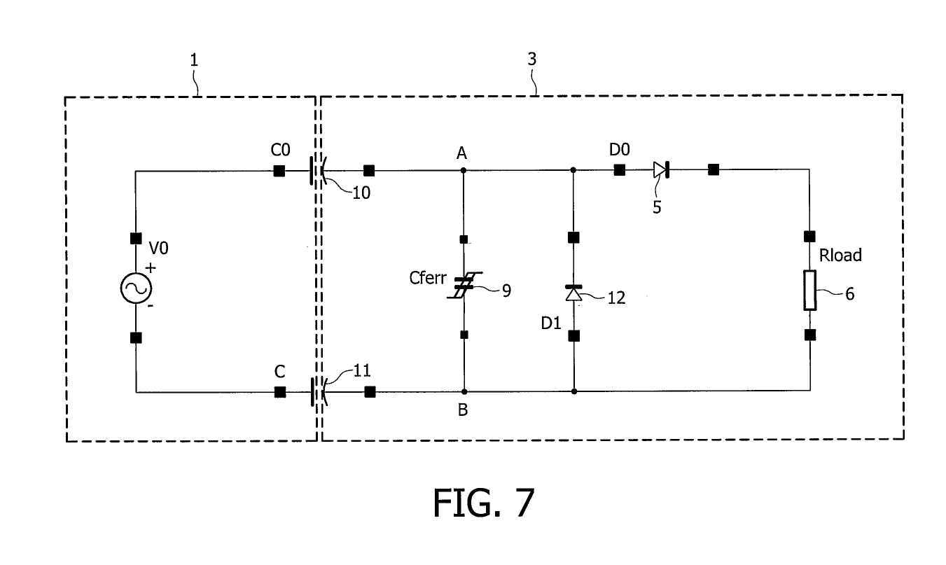

FIG. 7 shows schematically a further embodiment of a radio frequency identification tag according to the invention.

FIG. 1 shows schematically a base station 1 with an antenna arrangement 2 and an identification tag 3 with a resonant circuit 4, a rectifier 5 and a non-linear resistor 6 modeling the tag electronics.

The radio frequency identification tag 3 gets the energy it needs from electromagnetic waves that are sent by the base station 1. A suitable antenna arrangement 2 optimizes the energy transfer towards the tag. The antennas are often loops, so that the EM link can be seen as a transformer with a low coupling coefficient, k. On the tag side, a parallel resonant circuit 4, centered at the carrier frequency, is attached to the antenna, in order to maximize the received voltage and thus the reading distance. The antenna 2 and the tag electronics are normally made on different substrates, which are coupled electrically and mechanically with a suitable bonding technique. The energy received by the tag 3 is rectified, conditioned and transferred to the electronics present on the tag, as a DC bias voltage. This DC voltage, Vchip, is typically a square root function of the power captured by the tag antenna.

Assuming that the transmitting antenna emits power in the space around it in an isotropic way, the power density available at a certain point in the space is inversely proportional to the square of the distance between the given point and the transmitting antenna. If perfect impedance matching is assumed, and polarization and antenna gain effects are neglected, the DC voltage available on the chip, Vchip, will be inversely proportional to the distance between transmitting antenna and tag. This means that the voltage Vchip can be quite different dependent on whether the tag 3 is close to or far from the transmitting antenna arrangement 2. The maximum value of Vchip, however, is typically limited (1-5V for silicon electronics, 20-40V for organic electronics).

When the tag 3 approaches the base station 1, the received voltage rapidly increases. The voltage on the tag 3 can then exceed the maximum voltage that the electronics can withstand and hence the tag 3 may be destroyed.

In silicon tags the electronics is protected against overvoltages by suitable circuits, generally based on p-n junction voltage references and transistors. An example of such an overvoltage protection arrangement for silicon tags is shown in FIG. 2. The overvoltage protection in this embodiment is formed by a diode (or series of diodes) 7 and a bipolar transistor 8. If the voltage Vchip exceeds the threshold voltage Vt of the diode 7 plus the base-emitter voltage Vbe of the bipolar transistor, a current will flow in the base of the transistor 8, causing the transistor to be switched on. The transistor 8 will then absorb a large amount of current from the resonant circuit 4, dumping the resonance and reducing the rectified voltage back to the value Vt+Vbe.

This approach according to the state of the art is impossible in organic electronics, as in organic circuits p-n junctions are not available. It is thus impossible to produce a reference voltage Vt. Even using diode-connected transistors would not work, as the only transistors available at the moment are pmos with a positive threshold, which means that the resulting diode would always be ON.

According to the invention, the overvoltage protection device is formed by a ferroelectric capacitor that is electrically connected, for example in parallel, with the resonant circuit 4. An embodiment of a tag with such an overvoltage protection device is illustrated in FIG. 3. The overvoltage protection device is formed therein by the ferroelectric capacitor 9, which is connected in parallel with the resonant circuit 4.

A ferroelectric capacitor is a non-linear device characterized by hysteresis in the displacement versus voltage characteristic. The displacement D can be represented by the relation D=Q*A≅P, where Q is the charge stored in the ferroelectric capacitor, A its area and P its polarization. FIG. 4 shows the D-V characteristics of an ideal ferroelectric capacitor. When, in an ideal ferroelectric capacitor, a voltage at least equal to the coercive voltage Vc is applied to the capacitor, the dielectric polarizes and indefinitely keeps its polarization state until a voltage at least equal to −Vc is applied. The polarization kept without any applied voltage is called remnant polarization, Ps. The ideal ferroelectric capacitor then switches between the two polarization states exactly at V=±Vc. In a real ferroelectric capacitor this polarization reversal does not occur exactly at the coercive voltage, but the transition between polarization states is more gradual. Moreover, even at voltages slightly lower than the coercive voltage, a partial polarization state and polarization reversal can be observed in loops, called non-saturated loops. The D-V characteristics of a ferroelectric capacitor showing the non-saturated loops are illustrated in FIG. 5. The curves display the displacement in Q/unit area (mC/m²) versus the applied voltage, suitably normalized.

For the clarification of the present invention two phenomena are relevant:

1. As can be seen in FIGS. 4 and 5, the capacitance, i.e. the slope of the Q-V characteristics, offered by a ferroelectric capacitor is approximately equal to the capacitance Co measured for small voltage signals except when a voltage close to Vc is reached and polarization reversal occurs.

2. The process of dipole orientation within the ferroelectric material produces a current peak in the device current during polarization reversal. Contrary to the capacitive current, this current always has the same sign of the applied voltage, so that an average power will be dissipated. The power dissipated in the device is needed to switch the dipole orientation of the ferroelectric material.

Summarizing, the ferroelectric capacitor can be seen as a capacitor that absorbs real power when the applied voltage gets close to the coercive value Vc and polarization reversal occurs.

The characteristics of a specific ferroelectric capacitor are illustrated in FIGS. 6A and 6B.

FIG. 6A shows the D-V characteristics of a 195 nm thick Strontium Bismuth Tantalum Niobate, abbreviated (SBTN), ferroelectric capacitor. The vertical axis indicates the displacement in C/m2 and the horizontal axis indicates the amplitude of the applied voltage in volts. The curve A corresponds to a maximum amplitude of 5V and the curve B to a maximum amplitude of 0.4 V. Main parameters are: Vc=0.98V, Co=1.6 μF/cm2, Ps=10 μC/cm2.

FIG. 6B shows the applied voltage in volts (curve B) and the corresponding switching current Isw in amperes (curve A) versus time (in seconds) in the same ferroelectric capacitor as FIG. 6A. The voltage amplitude exceeds the coercive value.

Ferroelectric capacitances can be made of numerous inorganic materials, such as Barium or Lead titanate, but some organic materials also exhibit ferroelectric behavior, such as for instance poly(vinylidene difluoride) (PVDF) or copolymers of vinylidene difluoride with trifluoroethylene p(VDF-TrFE). Also composite materials consisting of mixtures of inorganic and/or organic ferroelectric materials with ferroelectric and non-ferroelectric matrices can be used.

As already stated and illustrated in FIG. 3, according to the invention a ferroelectric capacitor is electrically connected in parallel with the resonant circuit 4. As long as the amplitude of Vo remains below the coercive voltage Vc all capacitances will be linear and the resonant circuit will behave normally. However, if the amplitude of Vo approaches or exceeds Vc, the ferroelectric capacitance will experience polarization reversal and exhibit its non-linear and dissipative behavior. This will result in detuning and a loss in the Q-factor of the resonant circuit. Both phenomena will cause dumping of Vo. In this way the circuit of FIG. 3 keeps the peak Vo voltage to a maximum close to Vc. When the amplitude of Vo drops back below the coercive value, the behavior of the ferroelectric capacitance will become linear again, its value will be close to Co and the losses due polarization reversal will disappear. Consequently, the original properties of the resonant circuit will be re-established.

A parallel ferroelectric capacitor can be applied, as described with reference to FIG. 3, to control the maximum voltage on an identification tag based on organic semiconductors (organic RFIDs). The maximum allowed voltage in this application is, in accordance with the state of the art, 20 to 40V.

The coercive voltage of a 150 nm-thick PVDF capacitor is ˜10V. Protection at a level of 20 to 40V can be easily obtained with a slightly thicker PVDF film, or by arranging some PVDF capacitors in series. PVDF ferroelectric capacitors can be integrated with organic tag electronics on the same substrate, providing an integrated solution to the problem of overvoltage protection in organic RFIDs. Experiments on integration have been successfully performed. A ferroelectric capacitor can also be integrated on the antenna substrate. Cost minimization will dictate the best choice.

Referring to the overvoltage protection of Si RFIDs, the state of the art solution, as illustrated in FIG. 2, offers some drawbacks:

1. The area of the shunting transistor used for protection purposes in a state of the art design can be estimated to be 10,000 square micron. This area corresponds in the same technology to ˜40 flip-flops, which is a considerable amount of logic for such a simple system. In other words, the protection is area consuming, and constitutes a cost factor.

2. The protection circuit has to be fast enough to be effective if the reader is close to the base station and the latter switches the power on and off. This means that considerable design effort is needed to insure the right speed.

3. The protection circuits described in the state of the art need the presence of a DC voltage bias, and hence of a rectifier, in the circuit. Many new applications have been shown, however, where no rectifier is connected to the antenna and the electronics is directly powered by the AC output of the resonator, in order to save precious Si area.

In an RFID Si chip, a ferroelectric capacitor could be integrated in the back end of the technology, on top of the Si active area, using ferroelectric capacitors already available to build embedded Ferroelectric Random Access Memories (FERAMs) or using films processed on purpose on top of the chip. This would eliminate the first problem, as the ferroelectric capacitor could be stacked on the electronics, resulting in smaller imprint and possibly lower cost. The proposed solution is also as fast as the switching of the ferroelectric systems, so it does not require any special design effort. Coercive voltages of most inorganic ferroelectrics are low enough to provide protection of modern integrated electronics (Vmax=1÷5V), but thin organic ferroelectrics can also be applied.

Inorganic and (preferably) organic ferroelectric capacitors can also be integrated in the antenna for Si tags.

Further, it may be noticed that the invention does not need any DC voltage to provide protection and can thus be applied also to all systems where an AC voltage is used to power the electronics directly. This eliminates the last problem connected with the use of state of the art protection circuits.

In FIG. 7 a further embodiment of an overvoltage protection on a radio frequency identification tag according the invention is shown. The electro-magnetic coupling between the base station 1 and the tag 3 is obtained, in this case, by means of capacitances 10 and 11 instead of an inductive coupling as described hereinabove. The tag has metallized pads that must be arranged close to corresponding pads attached to the base station. In this way a capacitive link can be established to transmit power and control signals from the base station to the tag and the identification code back to the base station. Capacitive coupling between base station and tags is applied for use in low cost, low frequency RFID systems. For capacitive tags a resonant circuit is not used on the tag side, as this would require impractically large inductors. In this case the protection works as follows: When the voltage between the nodes A and B is lower than the coercive voltage of the ferroelectric capacitor 9, this capacitor 9 has to be chosen in such a way that it offers a much smaller capacitance than the coupling capacitances 10 and 11. In this way the presence of the ferroelectric capacitor 9 does not affect the normal operation of the circuit and a DC signal is generated by the two diodes 5 and 12 across the load. It may be noticed that the diode 12 is needed to provide a path for DC current and can be considered as a freewheeling diode. If the AC voltage between A and B grows to a value comparable with the coercive voltage of the ferroelectric capacitor 9, then the capacitance of the ferroelectric capacitor will increase sensibly. This means that the impedance offered to the AC signal from the ferroelectric capacitor decreases and the voltage between A and B is reduced. When the voltage between A and B is lower than the coercive voltage, the capacitance offered by the ferroelectric capacitor decreases again, and the circuit works as in the initial situation. In this way an excessive AC voltage between nodes A and B is effectively damped and brought back to a safe value. Of course, also in this case a series connection of ferroelectric capacitors can be applied.

1. Overvoltage protection device on a radio frequency identification tag or in a radio frequency receiver, comprising electro-magnetic coupling means between a base station and the radio frequency identification tag or radio frequency receiver, having at least one ferroelectric capacitor that is electrically connected to the coupling means.

2. Overvoltage protection device of claim 1, wherein the electro-magnetic coupling means comprise a resonant circuit connected to an antenna that receives energy from a base station, and the at least one ferroelectric capacitor is electrically connected to the resonant circuit.

3. Overvoltage protection device of claim 1, wherein the electro-magnetic coupling means take the form of capacitances between the base station and the radio frequency identification tag or radio frequency receiver, and the at least one ferroelectric capacitor is electrically connected to the capacitances.

4. Overvoltage protection device of claim 1, wherein at least two ferroelectric capacitors in serial configuration are electrically connected to the coupling means.

5. Overvoltage protection device of claim 1, wherein the at least one ferroelectric capacitor is connected in parallel with the coupling means.

6. Overvoltage protection device of claim 1, wherein the at least one ferroelectric capacitor is integrated on the electronic chip that is to be protected.

7. Overvoltage protection device of claim 1, wherein the at least one ferroelectric capacitor is integrated on the antenna providing energy to the electronics that is to be protected.

8. Overvoltage protection device of claim 1, wherein the at least one ferroelectric capacitor is made using organic ferroelectric dielectric films.

9. Radio frequency receiver provided with the overvoltage protection device of claim 1

10. Radio frequency identification tag provided with the overvoltage protection device of claim 1.
